(19) United States
(12) Patent Application Publication
(10) Pub. No.: US 2006/0061901 A1
(43) Pub. Date: Mar. 23, 2006

(54) Glass substrate for magnetic disks

(75) Inventors: Osamu Miyahara, Tokyo (JP); Masami Kaneko, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: ASAHI GLASS COMPANY LIMITED, Tokyo (JP)

(21) Appl. No.: 11/201,386

(22) Filed: Aug. 11, 2005

(30) Foreign Application Priority Data
Aug. 31, 2004 (JP) 2004-253211

(51) Int. Cl. G11B 19/02

(52) U.S. Cl. 360/69

(57) ABSTRACT

A glass substrate for magnetic disks, which is a doughnut-type glass substrate having a cut hole at its center, wherein the inner peripheral edge surface at the cut hole is covered with a coating film formed by curing a silicone resin and providing a contact angle of at least 30°.

The present invention relates to a glass substrate for magnetic disks which has high strength and is hardly stained.

As a substrate for magnetic disks to be used for e.g. magnetic disk memory devices, an aluminum alloy substrate has been mainly employed. However, along with the demand for high density recording, a glass substrate has now been employed which is excellent in flatness and smoothness and of which the base material itself is hard as compared with an aluminum alloy substrate. However, a glass substrate for magnetic disks, made of glass which is a brittle material, is likely to break during handling or during use, which is regarded as one of the problems.

One of factors governing the mechanical strength of a doughnut-type glass substrate for magnetic disks, is scars which are present on the inner peripheral edge surface of the glass substrate where the maximum tensile stress will be exerted by high speed rotation during use of the magnetic disks. In a glass substrate for magnetic disks, it is common that the surface roughness of the inner peripheral edge surface and the outer peripheral edge surface (hereinafter sometimes generally referred to as the inner and outer peripheral edge surfaces) is coarse as compared with the main surface (the surface other than the inner and outer peripheral edge surfaces) required to have very high levels of flatness and smoothness. Namely, the inner and outer peripheral edge surfaces are cut surfaces formed by cutting or coring a disk out of a glass plate into a doughnut shape, and they are not concerned with the magnetic recording. Besides, they are curved surfaces, which require a high cost for finish processing, whereby finish processing can not adequately be carried out.

In order to reduce the depth of scars on the inner and outer peripheral edge surfaces and thereby to improve the mechanical strength, finish processing of the inner and outer peripheral edge surfaces is carried out with abrasive grains finer than #500 mesh, but considerably deep scars may still remain on the inner and outer peripheral edge surfaces. In order to improve the finishing of the inner and outer peripheral edge surfaces, that is, in order to decrease the roughness, multi-step processing is required by means of abrasive grains having stepwisely reduced grain sizes. However, such multi-step processing has a problem that productivity will thereby be substantially deteriorated, and the cost remarkably increases.

As a glass substrate to solve the above mentioned problems, JP-A-2-301017 discloses a glass substrate for information recording disks, wherein a continuous layer of an oxide or a continuous layer composed mainly of an oxide having a thickness of from 0.2 to 50 μm, is formed on the inner peripheral side surface or on the inner peripheral side surface and the surface portion along the inner periphery.

It is disclosed that such a continuous layer of an oxide or a continuous layer composed mainly of an oxide preferably contains at least one member selected from Si, Ti, Al and Zr. Further, it is described to be effective to provide such a continuous layer after subjecting a circular processed glass substrate for magnetic disks to etching with hydrofluoric acid or buffered hydrofluoric acid or to leaching with sulfuric acid or nitric acid with a view to removing scars.

Further, it is disclosed that for the formation of the continuous layer, it is necessary to employ a so-called wet process wherein coating is carried out in the form of a solution or a slurry, followed by drying and heat treatment to obtain a cured film. Further, the same publication discloses an Example wherein a SiO₂ continuous layer having a thickness of 2 μm is formed on a glass disk surface by means of a colloidal silica dispersed in ethanol and a sol prepared by hydrolyzing ethyl silicate with an aqueous nitric acid solution, and an Example wherein a SiO₂ continuous layer partially containing an organic layer having a thickness of 5 μm, is formed on a glass disk surface by means of monomethyltrimethoxysilane, water glass-type colloidal silica and nitric acid.

However, in the continuous layer disclosed in JP-A-2-301017, water and organic substances are likely to remain. If a glass substrate having such a continuous layer formed on the surface, is introduced into a vacuum process for the production of a magnetic disk, generation of gas is likely to occur due to the water and organic substances remaining in the continuous layer thereby to deteriorate the properties of the magnetic film. Further, in order to form the continuous layer, highly precise adjustment of the viscosity and the pH of the coating liquid is required, and there is a problem from the viewpoint of the operation efficiency.

As a glass substrate to solve the above problems of the continuous layer of an oxide, for example, JP-A-11-328665 discloses a glass substrate for magnetic disks produced in such a manner that a coating composition containing a polysilazane is coated and cured on the etching-treated inner peripheral edge surface of a doughnut-type glass substrate to form a protective film having a hardness corresponding to a pencil scratch value of at least 5 H, and then the main surface of the doughnut-type glass substrate is polished.

However, although the conventional continuous layer of an oxide or the coating film of a silica layer formed from a polysilazane functions as a protective film or a reinforcing film on the inner peripheral edge surface of a doughnut-type glass substrate, moisture or a wet stain is likely to adhere to the continuous layer or the coating film during handling or during use of the glass substrate for magnetic disks. Accordingly, the quality or performance of magnetic disks often decreases.

Under these circumstances, it is an object of the present invention to provide a high quality glass substrate for magnetic disks which is hardly stained, whereby the above-described problems of a glass substrate for magnetic disks which is a doughnut-type glass substrate with its inner peripheral edge surface covered with a coating film are solved.

In order to achieve the above object, the present inventors have conducted extensive studies on prevention of stain of a glass substrate for magnetic disks with its inner peripheral edge surface covered with a coating film and as a result, found that stain-proofness can be achieved by covering the inner peripheral edge surface of a doughnut-type glass substrate with a coating film providing a large contact angle, i.e. a coating film poor in wettability, and the present invention has been accomplished on the basis of this discovery. Namely, the present invention provides the following glass substrate for magnetic disks.

(1) A glass substrate for magnetic disks, which is a doughnut-type glass substrate having a cut hole at its center, wherein the inner peripheral edge surface at the cut hole is covered with a coating film formed by curing a silicone resin and providing a contact angle of at least 30°.

(2) The glass substrate for magnetic disks according to the above (1), wherein the coating film provides a contact angle of at least 32°.

(3) The glass substrate for magnetic disks according to the above (1) or (2), wherein the coating film has a thickness of at least 0.5 μm.

(4) The glass substrate for magnetic disks according to any one of the above (1) to (3), wherein the silicone resin is a methyl phenyl silicone resin.

(5) The glass substrate for magnetic disks according to any one of the above (1) to (4), wherein the coating film is formed on the outer peripheral edge surface of the doughnut-type glass substrate.

It is considered that both the conventional continuous layer of an oxide and the coating film of a silica layer formed from a polysilazane provide a small contact angle, as an index of wettability, of usually at most about 20°, whereby moisture or a wet stain is likely to adhere to the continuous layer or the coating film during handling or during use of the glass substrate for magnetic disks.

According to the present invention, a glass substrate for magnetic disks, which is a doughnut-type glass substrate for magnetic disks with its inner peripheral edge surface covered with a coating film providing a large contact angle, to which moisture or a wet stain is thereby less likely to adhere, is obtained.

Further, since the inner peripheral edge surface of the glass substrate for magnetic disks is covered with a coating film, formation of fine glass foreign matters (particles) from the inner peripheral edge surface can be prevented. Further, a glass substrate for magnetic disks having high strength can be obtained by forming such a coating film on an etching-treated inner peripheral edge surface.

Further, the silicone resin of the present invention is less restricted regarding coating conditions such as the temperature or the pH of a coating liquid, and is thereby excellent in operation properties and is less limited in operation.

In the accompanying drawing:

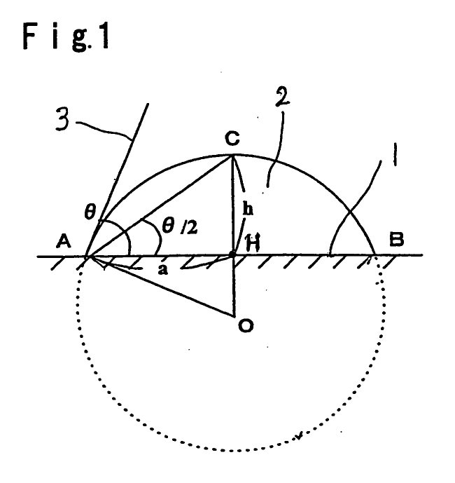

FIG. 1 is a diagram explaining the contact angle of a coating film in the present invention.

Now, the present invention will be described in detail with reference to the preferred embodiments.

The doughnut-type glass substrate of the present invention is a doughnut-type, i.e. a glass substrate having a circular disk shape with a predetermined radius and having a circular cut hole having the same center as the center of the disk at a center portion of the disk, and having an inner peripheral edge surface, an outer peripheral edge surface and front and back main surfaces.

The dimensions of the doughnut-type glass substrate are not particularly limited, and the dimensions as represented by mm may, for example, be such that (a) inner diameter 7.0, outer diameter 21.4, plate thickness 0.38, (b) inner diameter 12.0, outer diameter 48.0, plate thickness 0.55, (c) inner diameter 25.0, outer diameter 84.0, plate thickness 1.0, (d) inner diameter 12.0, outer diameter 48.0, plate thickness 0.5, or (e) inner diameter 25.0, outer diameter 95.0, plate thickness 0.8.

The glass substrate for magnetic disks of the present invention is characterized in that the inner peripheral edge surface of the doughnut-type glass substrate is covered with a coating film formed by curing a silicone resin and providing a large contact angle. Namely, the inner peripheral edge surface is covered with a coating film providing a contact angle larger than that of the above conventional coating film of an oxide or a silica layer. In the present invention, the contact angle represents, when a droplet 2 is present on a coating film 1 in an atmospheric air as shown in FIG. 1, an angle θ among angles formed by the coating film and a tangent line 3 drawn on the droplet 2 at a contact point A of the coating film, the droplet and the air, which includes the droplet 2. The contact angle varies depending upon the type of the droplet and further varies depending upon the type of the coating film, i.e. properties of the coating film surface. The contact angle in the present invention is a contact angle when the droplet comprises pure water, and a larger contact angle represents stronger water repellency of the coating film, and moisture will hardly adhere to the coating film.

In the present invention, the contact angle θ of the droplet 2 is measured in accordance with the following method. The cross section of the droplet 2 is assumed to be a part of a circle as shown in FIG. 1. In FIG. 1, the upper ACB is an arc representing the cross section of the droplet, and the point C represents the apex of the droplet 2. In FIG. 1, the contact angle θ to be determined is equal to the angle of circumference of the upper arc ACB. The apical angle of the isosceles triangle OAC, i.e. the angle AOC=θ, and the angle ACO=90°−θ/2, whereby in the right triangle CAH, the angle CAH=θ/2.

Accordingly, the contact angle θ can be determined by taking a photograph of the droplet 2 on the coating film 1 and drawing a straight line corresponding to AC in FIG. 1, and multiplying the angle formed by this straight line and the horizontal line by 2. However, direct measurement of the angle is likely to lead to an error, and thus the contact angle θ is determined preferably from the formula θ=2·arctan(h/a) by measuring a and h in FIG. 1. The contact angle θ in the present invention is determined from the above formula.

The photograph of the droplet 2 is taken as follows. Pure water is injected in a microsyringe, and a water droplet of 4 microliter or smaller (amount which will not be influenced by gravity) is formed on the needle tip of the microsyringe. When this water droplet is in contact with the coating film 1, the microsyringe is lifted to form a droplet (water droplet) 2 on the coating film. Then, the droplet 2 is photographed from the side by e.g. a fiberscope and printed to prepare a photograph of the water droplet. From this photograph, the radius (a) and the height (h) of the water droplet are measured to calculate the contact angle.

In the present invention, the contact angle is at least 30°, preferably at least 32°, more preferably at least 35°, particularly preferably at least 40°. Particularly when the inner peripheral edge surface of the glass substrate for magnetic disks is covered with a coating film which provides a contact angle of at least 30°, moisture or a wet stain is less likely to adhere to the inner peripheral edge surface during handling, during processing or during use of the glass substrate for magnetic disks. Here, the wet stain means a stain or an impurity such as abrasive grains dispersed or dissolved in moisture, which may cause decrease in quality of the glass substrate for magnetic disks.

In the present invention, the coating film is formed as a film formed by curing a silicone resin as mentioned above. Specifically, it can be formed in such a manner that a coating liquid having a predetermined concentration is prepared by using a silicone resin and a solvent, the inner peripheral edge surface of a glass substrate for magnetic disks is coated with the coating liquid, and the applied coating liquid is dried and then cured e.g. by firing. As a coating method, the following methods may, for example, be mentioned. However, the coating method is not limited thereto.

(1) A brush coating method wherein coating is carried out by means of a brush.

(2) A roller coating method wherein a coating liquid is supplied to a porous surface of a roller brush made of e.g. a foamed plastic, and the roller of the roller brush is rotated at a rotational speed of from 10 to 60 rpm, so that it is brought in contact with the inner peripheral edge surface or the inner and outer peripheral edge surface of the doughnut-type glass substrate to transfer and coat the coating liquid.

(3) A direct coating method wherein the doughnut-type glass substrate is vacuum-adsorbed and rotated at a rotational speed of from 10 to 200 rpm, and a predetermined amount of a coating liquid is supplied from a dispenser and coated on the inner peripheral edge surface, or on the inner and outer peripheral edge surface.

The coating film formed by the above method comprises a silicone resin layer and provides a contact angle of at least 30°. Further, in the molecular structure of the silicone resin, the siloxane bond which forms the main skeleton has a high bond energy, whereby the silicone resin has a high thermal decomposition temperature and the coating film is thereby very excellent in heat resistance. Resultingly, a gas is less likely to be generated by heating even if there is a step of heating the glass substrate in the process for producing a magnetic disk, and properties of the magnetic disk are less likely to be lowered. Further, the coating film covers the inner peripheral edge surface of the glass substrate and thereby obviously functions also as a protective film for the inner peripheral edge surface, and has an effect to suppress formation of particles.

The silicone resin is roughly classified into a straight silicone resin employing properties of the silicone itself and a modified silicone resin having various characteristics of another resin added by modification. Further, the straight silicone resin is classified into a methyl silicone resin and a methyl phenyl silicone resin, and as representative examples of the modified silicone resin, alkyd modification, epoxy modification, acrylic modification and polyester modification may, for example, be mentioned, and they may be used as a silicone resin in the present invention.

Among the above silicone resins, a straight silicone resin is particularly desirable in view of excellent flame retardant properties, and among straight silicone resins, a methyl phenyl silicone resin is particularly preferred in the present invention in view of particularly excellent flame retardant properties. When a coating film is formed from the silicone resin, a coating liquid therefor usually contains a solvent in addition to the silicone resin. Further, it may contain a catalyst or other additives in addition to the solvent.

The thickness of the coating film of the present invention is preferably at least 0.5 μm, more preferably at least 1 μm. If the thickness of the coating film is less than 0.5 μm, when the inner peripheral edge surface is a ground surface, the coating film, which is thin, is strongly influenced by the surface roughness, whereby a favorable coating film which provides a large contact angle may hardly be obtained. Further, the upper limit of the thickness of the coating film is not particularly limited, but the contact angle will not substantially increase even when the film thickness is increased exceeding a certain thickness, and in addition, formation of such a thick coating film tends to be difficult, and accordingly it is usually at a level of 5 μm.

In the present invention, the coating film can be formed on a ground surface formed by grinding the inner peripheral edge surface of the doughnut-type glass substrate. The ground surface can be obtained as a surface having a predetermined surface roughness (Ra) by carrying out finish processing on the inner peripheral edge surface by using abrasive grains at a level of from #200 to #1,000 mesh for example, and further, as the case requires, by using abrasive grains having stepwisely reduced grain sizes. A preferred surface roughness can be obtained usually by grinding the inner peripheral edge surface with abrasive grains at a level of from #300 to #500 mesh. The surface roughness (Ra) of the ground surface is preferable at most 1.0 μm, more preferably at most 0.7 μm. If the surface roughness (Ra) of the inner peripheral edge surface is greater than 1.0 μm, depth of scars on the ground surface tends to increase correspondingly, whereby mechanical strength of the magnetic disk tends to decrease, the amount of particles formed tends to increase, or formation of a smooth and favorable coating film tends to be difficult. By forming a coating film on such a ground inner peripheral edge surface, significant improvement in productivity and reduction in cost will be achieved.

Further, the coating film may be formed on the inner peripheral edge surface which is ground and then further subjected to mirror finish processing or on the inner peripheral edge surface which is ground and then subjected to an etching treatment by a method as described hereinafter. The mirror finish processing or the etching treatment increases the cost, but by forming the coating film on such a processed inner peripheral edge surface, a glass substrate for magnetic disks having high strength will be obtained. Further, as the case requires, chamfering may be applied to the inner peripheral edge surface or the inner and outer peripheral edge surfaces of the doughnut-type glass substrate.

Further, by forming a coating film similarly on the outer peripheral edge surface of the doughnut-type glass substrate with the inner peripheral edge surface covered with the coating film, it becomes possible to prevent stain or to suppress formation of particles on the outer peripheral edge surface.

The type of glass to be used for the glass substrate for magnetic disks of the present invention is not particularly limited, but for the improvement of the weather resistance, a glass having the following characteristics is preferred.

Water resistance: When the glass is immersed in water of 80° C. for 24 hours, the weight reduction of the glass (eluted amount) due to elution of components from the glass, is not more than 0.02 mg/cm².

Acid resistance: When the glass is immersed in a 0.1 N hydrochloric acid aqueous solution of 80° C. for 24 hours, the weight reduction of the glass (eluted amount) due to elution of components from the glass, is not more than 0.06 mg/cm².

Alkali resistance: When the glass is immersed in a 0.1 N sodium hydroxide aqueous solution of 80° C. for 24 hours, the weight reduction of the glass (eluted amount) due to elution of components from the glass is not more than 1 mg/cm², more preferably not more than 0.18 mg/cm².

In the present invention, it is not required to use a chemical reinforcing method, and there is no lower limit in the content of an alkali metal such as Na or Li as the composition of the glass with a view to making chemical reinforcement possible. The glass which may be used for the glass substrate for magnetic disks of the present invention, may, for example, be a glass having an alkali metal oxide content of from 1 to 20 mass %, such as soda lime silica glass, alumina silicate glass, alkali-free glass or crystallized glass.

As one embodiment of the present invention, as mentioned above, the coating film may be formed on the inner peripheral edge surface or the inner and outer peripheral edge surfaces of the doughnut-type glass substrate subjected to etching treatment. For the etching treatment, a common etching method for glass, such as a wet etching method by means of an etching liquid or a dry etching method by means of an etching gas, may, for example, be used. Among them, a wet etching method employing an etching liquid such as a hydrofluoric acid solution, a hydrofluoric sulfuric acid solution or silicofluoric acid, can be suitably employed. Particularly preferred is a method employing a hydrofluoric sulfuric acid solution. Such etching treatment is carried out preferably within a range not to form high projections on the glass substrate surface.

By the etching treatment, it is possible to remove deep scars present on the inner and outer peripheral edge surfaces, which govern the bending strength of the doughnut-type glass substrate, particularly deep scars on the inner peripheral edge surface, which more strongly govern the bending strength. The etching depth by the etching treatment is preferably from 3 to 40 μm. If the depth is less than 3 μm, removal of deep scars present particularly on the inner peripheral edge surface tends to be inadequate, whereby the mechanical strength tends to be low. If it exceeds 40 μm, high projections are likely to form on the glass substrate surface.

Now, the present invention will be described in further detail with reference to Examples. However, it should be understood that the present invention is by no means restricted to such specific Examples.

15 sheets of circular glass substrates having an outer diameter of 65 mm and a thickness of 0.9 mm were prepared which were made of glass having a composition comprising, as calculated as oxides, 56 mass % of SiO₂, 6 mass % of B₂O₃, 11 mass % of Al₂O₃, 0.05 mass % of Fe₂O₃, 0.1 mass % of Na₂O, 2 mass % of MgO, 3 mass % of CaO, 15 mass % of BaO and 6.5 mass % of SrO. The eluted amounts (unit: mg/cm²) in the tests on water resistance, acid resistance and alkali resistance of this glass, were 0.01, 0.03 and 0.67, respectively.

The outer peripheral edge surface of the above circular glass substrates was subjected to finish polishing with diamond abrasive grains smaller than #500 mesh, and then the glass substrates were subjected to lapping with alumina abrasive grains having an average particle size of 9 μm and polished until the thickness became about 0.7 mm. Such glass substrates were further immersed in a hydrofluoric sulfuric acid solution containing 5% each of hydrofluoric acid and sulfuric acid, for 15 minutes to carry out etching treatment to an etching depth of about 20 μm.

Using the above glass substrates, three experiment samples were prepared for each Example by the following method. The contact angle (unit: degree) was measured by the above method with respect to the respective samples, and further, evaluation of stain was carried out by means of the following test methods 1 and 2 with respect to two samples among three. Further, evaluation of the result in each test method was made based on standards ◯: good, Δ: fair and x: poor. Further, overall evaluation of stain based on the results in the test methods 1 and 2 was made based on standards ◯: less stained, Δ: fair and x: easily stained.

Method of Evaluating Stain

Test method 1: 3 mg of a slurry containing cerium oxide abrasive grains (average particle size: 1.2 μm, solid content: 12 mass %) is dropped on each sample, and then the sample is rotated by a spin coater at a number of revolution of 700 rpm for 5 seconds. After completion of the rotation, the sample is dried in an electric furnace at 100° C. for 10 minutes, and the amount of solid content of cerium oxide remaining on the sample is evaluated by weight (unit: 10⁻⁴ g).

Test method 2: 3 mg of the above slurry is dropped on the sample, the sample is dried in an electric furnace at 100° C. for 10 minutes, and then the sample is put in an ultrasonic cleaner (ultrasonic cleaning conditions: 100 kHz, 3 minutes), and the degree of removal of remaining cerium oxide is evaluated based on the following formula:
{the amount of cerium oxide remaining after the ultrasonic cleaning (×10⁻⁴ g)}/{the weight of cerium oxide attached to the sample (×10⁻⁴ g)}×100 (as represented by %)

### EXAMPLE 1

The surface (upper surface) of each of the above glass substrates (three sheets) was coated by brush coating with a xylene solution (solid content concentration of 7 mass %) of a straight silicone resin (“KR282”, trade name, manufactured by Shin-Etsu Silicones), and the solution was dried in an electric furnace at from 100 to 150° C. for from 10 to 30 minutes, heated in the electric furnace at 350° C. for 30 minutes and cured to form a coating film of the silicone resin, whereby samples were prepared. The thickness of the coating films formed was from 2 to 3 μm on the average.

The contact angle was measured and the evaluation of stain was carried out on an optional portion on each of the coating films of the above samples. The results are shown in Table 1.

### EXAMPLE 2

In the same manner as in Example 1, coating films having an average film thickness of from 2 to 3 μm were formed on the surface (upper surface) of the above glass substrates (three sheets) by using a xylene solution (solid content concentration: 7 mass %) of a silicone resin (“SE9186” manufactured by Dow Corning Toray Co., Ltd.).

The contact angle was measured and evaluation of stain was carried out on an optional portion of each of the coating films of the above samples. The results are shown in Table 1.

### EXAMPLE 3

In the same manner as in Example 1, coating films having an average film thickness of from 2 to 3 μm were formed on the surface (upper surface) of the above glass substrates (three sheets) by using a xylene solution (solid content concentration: 7 mass %) of a straight silicone resin (“KR311”, trade name, manufactured by Shin-Etsu Silicones).

The contact angle was measured and evaluation of stain was carried out on an optional portion of each of the coating films of the above samples. The results are shown in Table 1.

### COMPARATIVE EXAMPLE 1

The contact angle on an etched surface (upper surface) of each of the glass substrates (three sheets) having no coating film formed thereon was measured, and the evaluation of stain on the etched surface was carried out in the same method. The results are shown in Table 1.

### COMPARATIVE EXAMPLE 2

The surface (upper surface) of each of the above glass substrates (three sheets) was coated with a xylene solution (solid content concentration: 20 mass %) of an organic type polysilazane (“L7101”, trade name, manufactured by TonenGeneral Sekiyu K. K.), and then the xylene solution was dried in an electric furnace at from 50 to 60° C. for from 10 to 20 minutes, and then the glass substrate was held in the electric furnace at 400° C. for 1 hour for curing thereby to form a coating film of the polysilazane. The thickness of the coating films was from 2 to 3 μm on the average.

The contact angle was measured and the evaluation of stain was carried out on an optional portion on each of the coating films of the samples. The results are shown in Table 1.

TABLE 1

| | Ex. 1 | | | Ex. 2 | | | Ex. 3 | | | Comp. Ex. 1 | | | Comp. Ex. 2 | | |
|---|---|---|---|---|---|---|---|---|---|---|---|---|---|---|---|
| | | Evaluation | | | Evaluation | | | Evaluation | | | Evaluation | | | Evaluation | |
| | | of stain | | | of stain | | | of stain | | | of stain | | | of stain | |
| Sample | Contact | Test | Test | Contact | Test | Test | Contact | Test | Test | Contact | Test | Test | Contact | Test | Test |
| No. | angle | 1 | 2 | angle | 1 | 2 | angle | 1 | 2 | angle | 1 | 2 | angle | 1 | 2 |
| 1 | 114.1 | 1.4 | — | 97.1 | 3.6 | — | 35.2 | — | — | 19.9 | 91.4 | — | 28.8 | — | — |
| 2 | 118.1 | — | — | 97.2 | — | 1.8 | 34.1 | 13.2 | — | 18.6 | — | 41.7 | 28.8 | 54.0 | — |
| 3 | 116.4 | — | 0.1 | 98.6 | — | — | 32.1 | — | 4.9 | 18.5 | — | — | 29.2 | — | 10.0 |
| Evaluation | | ◯ | ◯ | | ◯ | ◯ | | ◯ | ◯ | | X | X | | X | Δ |
| results | | | | | | | | | | | | | | | |

| | | | | | |
|---|---|---|---|---|---|
| Overall | ◯ | ◯ | ◯ | X | Δ |
| judgment | | | | | |

As evident from Table 1, it is found that the coating films of Examples 1, 2 and 3 of the present invention provide a large contact angle, give an excellent result in the evaluation of stain and are less likely to be stained as compared with Comparative Examples 1 and 2.

Here, the experiment was carried out by forming a coating film on the surface of the circular glass substrate, since it is difficult to measure the contact angle and to carry out evaluation of stain with respect to a coating film formed on the inner peripheral edge surface of a doughnut-type glass substrate. However, this result is substantially equal to that to be obtained when the same coating film is formed on the inner peripheral edge surface of a doughnut-type glass substrate.

The present invention provides a glass substrate for magnetic disks, which is a doughnut-type glass substrate with its inner peripheral edge surface or its inner and outer peripheral edge surfaces covered with a coating film which provides a large contact angle, whereby moisture or a wet stain is less likely to adhere to the inner peripheral edge surface or the inner and outer peripheral edge surfaces, and further, particles are less likely to form from the inner peripheral edge surface or the inner and outer peripheral edge surfaces, and such a glass substrate is useful as a high quality glass substrate for magnetic disk.

The entire disclosure of Japanese Patent Application No. 2004-253211 filed on Aug. 31, 2004 including specification, claims, drawings and summary is incorporated herein by reference in its entirety.

What is claimed is:

1. A glass substrate for magnetic disks, which is a doughnut-type glass substrate having a cut hole at its center, wherein the inner peripheral edge surface at the cut hole is covered with a coating film formed by curing a silicone resin and providing a contact angle of at least 30°.

2. The glass substrate for magnetic disks according to claim 1, wherein the coating film provides a contact angle of at least 32°.

3. The glass substrate for magnetic disks according to claim 1, wherein the coating film has a thickness of at least 0.5 μm.

4. The glass substrate for magnetic disks according to claim 1, wherein the silicone resin is a methyl phenyl silicone resin.

5. The glass substrate for magnetic disks according to claim 1, wherein the coating film is formed on the outer peripheral edge surface of the doughnut-type glass substrate.
